(19) United States
(12) Patent Application Publication
(10) Pub. No.: US 2013/0139614 A1
(43) Pub. Date: Jun. 6, 2013

(54) PORTABLE TORQUE WORK STATION AND ASSOCIATED TORQUING METHOD

(71) Applicants: David C. Johnson, West Hartford, CT (US); Lawrence A. Marrington, Farmington, CT (US)

(72) Inventors: David C. Johnson, West Hartford, CT (US); Lawrence A. Marrington, Farmington, CT (US)

(21) Appl. No.: 13/311,515

(22) Filed: Dec. 5, 2011

(51) Int. Cl. G01L 5/24; G01L 3/02

(52) U.S. Cl. 73/862.21; 73/862.191

(57) ABSTRACT

An exemplary component torquing method includes applying torque to a component during an evaluation pass and collecting data during the evaluation pass. The method uses the data to customize a torque procedure for the component that will help ensure the component has a desired clamp load after the torque procedure. The method then torques the component according to the torque procedure.

### BACKGROUND

This disclosure relates to a portable torque workstation and, more particularly, to a torquing method used by the portable torque workstation.

Torque devices apply torque to a component as known. The torque, measured typically in inch-pounds, rotates the component. Torque devices typically rotate the component relative to another fixed or stationary component. Example components include a bolt or a nut, one of which is stationary and the other meant to be torqued. Torquing is not the final objective, rather, the final objective of a torquing procedure is the resultant clamp load, measured typically in pounds. Once torqued, the component applies a clamp load. The clamp load applied by an installed component relates, in part, to how torque is applied to the component (speeds, sequence, etc.).

In the prior art, operators apply torque to a component according to a torque procedure specified by a designer. The torque specified by the designer does not necessarily result in the component applying the desired clamp load. Many factors influence the clamp load applied by the component such that the variation of each factor can combine resulting in an unacceptable clamp load.

### SUMMARY

An exemplary component torquing method includes a three pass torquing sequence. The first pass, the evaluation pass, applies torque to a component and collects data while doing it. The second pass backs off the component to the neutral position, again collecting data while doing it. The data from the first two passes is used to instantaneously calculate the torque and final angle of turn (AOT) required to meet the designed clamp load and/or any other positional requirements. The third and final “seating” pass then torques to the calculated torque and AOT. In short, this method uses real-time data to determine a customized torque procedure for the component that will help ensure the component has a desired clamp load after the torque procedure. The method then torques the component according to the torque procedure.

Another exemplary component torquing method includes torquing a component during an evaluation pass and using information from the evaluation pass to determine a torque procedure that will result in the component having the desired clamp load. The method then performs the torque procedure on the component.

An exemplary portable torque work station includes a torque tool and a controller that controls the torque tool to apply a torque procedure to a component. The torque procedure is determined by the controller at the location of the component and is based in part on the data collected when applying torque to the component during an evaluation pass.

### DESCRIPTION OF THE FIGURES

The various features and advantages of the disclosed examples will become apparent to those skilled in the art from the detailed description. The figures that accompany the detailed description can be briefly described as follows:

FIG. 1 shows a perspective view of an example portable torque workstation.

FIG. 2A shows a schematic view of the FIG. 1 portable torque workstation engaged with a component of a turbomachine after an evaluation pass.

FIG. 2B shows a schematic view of the FIG. 1 portable torque workstation engaged with the first component of the turbomachine after a back-off pass.

FIG. 2C shows a schematic view of the FIG. 1 portable torque workstation engaged with the component of the turbomachine after applying a torque to the first component according to a torque procedure.

FIG. 3 shows the flow of an example method of torquing a component utilizing the portable torque workstation of FIG. 1.

### DETAILED DESCRIPTION

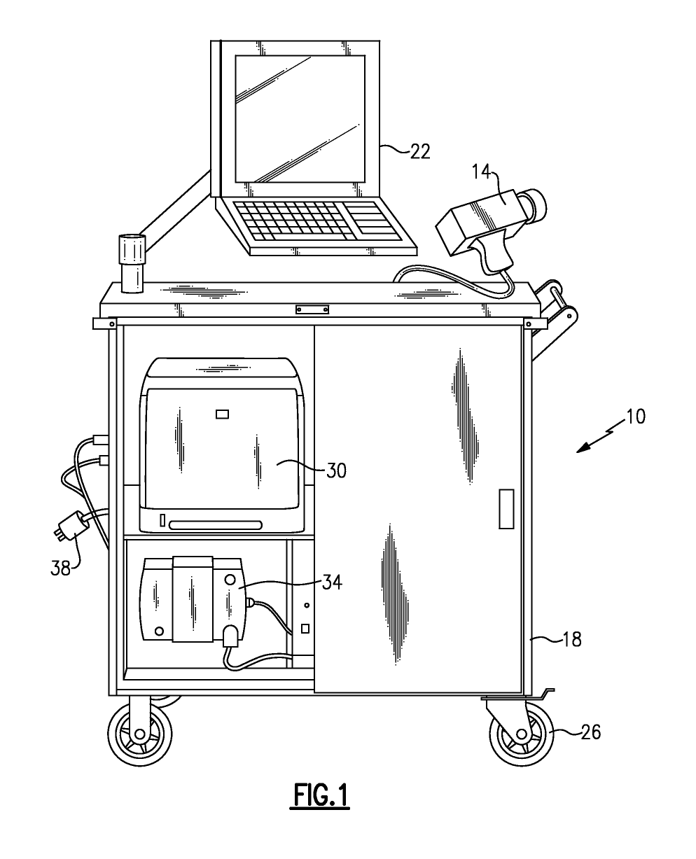

Referring to FIG. 1, an example portable torque workstation 10 includes a torque tool 14, a cabinet 18, a computer 20, and a display 22. The cabinet 18 of the portable torque workstation 10 is mounted to solid-tread caster wheels 26, which facilitate moving the portable torque workstation 10 across a shop floor, for example.

The cabinet 18 also contains a printer 30, a back-up power supply 34, and a plug 38 for electrically coupling the portable torque workstation 10 to a primary source of power. The cabinet 18 may include dedicated wiring channels. The power handling equipment of the cabinet 18 ensures that the torque tool 14, the computer 20, and the display 22 receive a relatively consistent, stable voltage supply.

The example portable torque workstation 10 is designed to receive power from a 480-volt, 30-amp or a 220-volt, 30-amp power source. Such power sources are particularly prevalent in shop environments and to control and monitor preassembly heating sources.

The example torque tool 14 is an electric torque wrench having a servo-motor. The torque wrench can handle torquing needs from 339 to 4339 newton meters (250 to 3,200 foot pounds) at 60 rotations per minute.

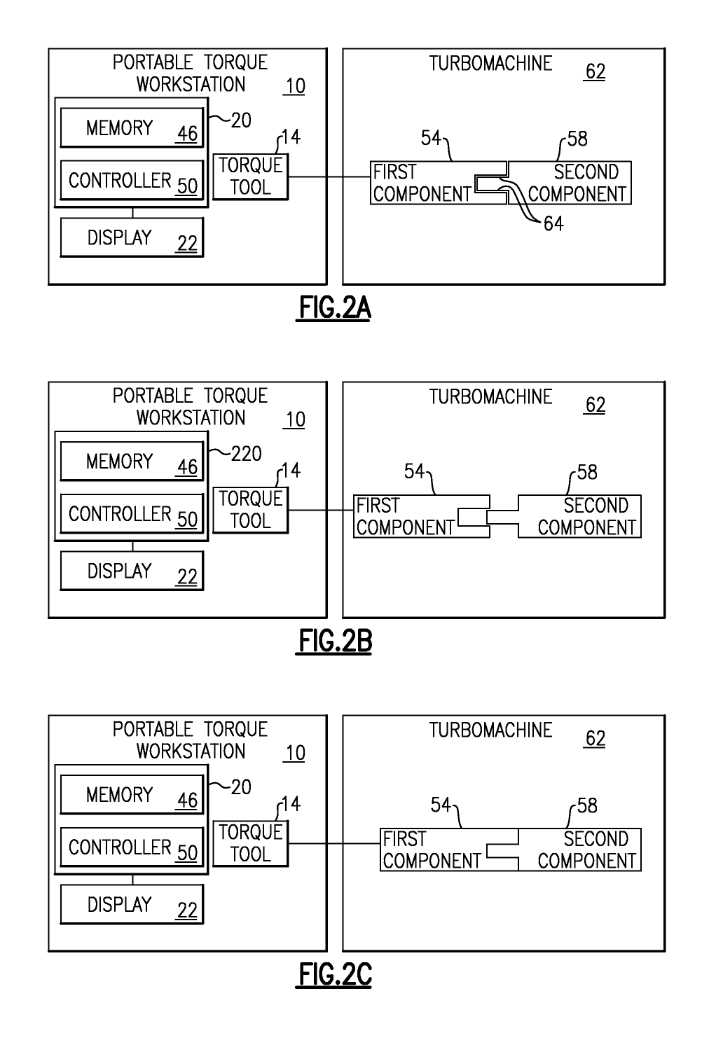

Referring now to FIGS. 2A-2C with continued reference to FIG. 1, the computer 20 of the portable torque workstation 10 includes a memory portion 46 and a controller 50. The controller 50 is configured to execute software stored in the memory portion 46. In one example, the software is Windows® XP-based software that has a flexible front end to enable downloading of upgrades and additional software modules. Calibration records for the torque tool 14 are also stored in the example memory portion 46.

The display 22 of the portable torque workstation 10 is a touch screen display. An operator utilizing interfaces with the various components of the portable torque workstation 10 through the display 22. The display 22 is sealed, which protects the display 22 from dirt and other contaminants. The display 22, and the remaining portions of the portable torque workstation 10, are ergonomically designed to enhance productivity.

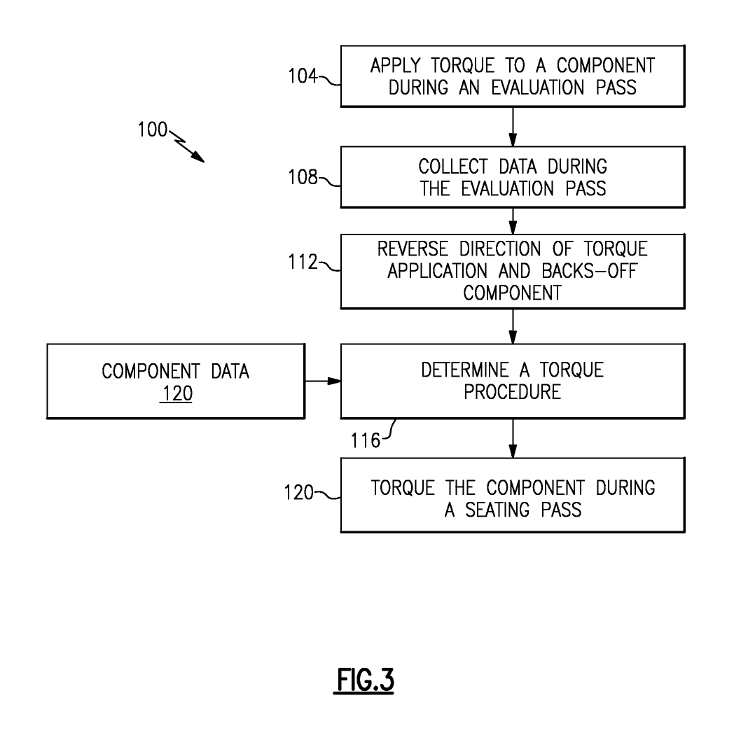

Referring now to FIG. 3 with continued reference to FIGS. 1-2C, an example method 100 of torquing a component utilizing the portable torque workstation 10 includes a step 104 of applying a torque to the component during an evaluation pass. Data is collected during the evaluation pass at a step 108.

The method then uses the torque tool 14 to rotate the first component 54 in an opposite direction relative to the second component at a step 112. Rotating the first component in the opposite direction backs the first component 54 off from the second component 58.

At a step 116, the method 100 determines a torque procedure. In this example, determining the torque procedure includes an evaluation of the data collected during the evaluation pass of the step 108, as well as component data from a step 120.

The method next utilizes the torque tool 14 to apply torque to the first component 54 during a seating pass. The torque applied during the seating pass is controlled by the torquing procedure, which, again, is based on both the component data from the step 120 and the evaluation pass data collected during the step 104. In the prior art, components are not torqued according to torque procedures that are based on data collected during an evaluation pass.

After the seating pass, the torque tool 14 is removed from the first component 54. The first component 54 exerts a desired clamp load against the second component 58 after the seating pass.

The schematic view of FIG. 2A shows a first component 54 and a second component 58 of a turbomachine 62 after the torque tool 14 has applied torque to the first component 54 during the evaluation pass.

The evaluation pass of the step 104 is different than the seating pass. The evaluation pass torques the first component 54 for the purpose of collecting data. The seating pass, by contrast, torques the first component 54 for the purpose of seating the first component 54 relative to the second component 58. The first component 54 may contact the second component 58 after the evaluation pass, but generally does not reach a seated position relative to the second component 58.

In this example, data collected during the evaluation pass includes variables used by the controller 50 to calculate static friction and dynamic friction as torque is applied to the first component 54. The static friction and the dynamic friction are calculated based on the amps required by the torque tool 14 to rotate the first component 54, for example.

Data collected during the evaluation pass may also include detecting burrs (obstructions) at interfaces 64 between the first component 54 and the second component 58. The burrs are detected based on the amps required by the torque tool 14 to rotate the first component 54, for example.

Notably, data collected during the evaluation pass may be specific to torquing a particular first component 54 within a plurality of components. That is, although the design of other components may be similar to the first component 54, the other components may experience different levels of the friction due to burrs or imperfections. The equivalent pass allows the torque procedure to account for these variations.

The evaluation pass of the portable torque workstation 10 adjusts the torque procedure for each component requiring torquing. The adjustments account for other differences in the components as well, such as damaged threads, dirt, and even dimensional differences due to varying production lots, for example. In some examples, the method 100 is referred to as a method of intelligent torquing due to the use of data specific to the first component 54.

In this example, the component data from the step 120 is stored in the memory portion 46 of the portable torque workstation 10. Such component data may include a name of the component, a clamp load target, a thermal energy level of the component, etc.

The component data also may specify that the component is torqued by coupling the torque tool 14 to the component using a Sweeney torque multiplier, rather than engaging the component directly with the torque tool 14. An example component having such component data is an oil-bearing nut in a high-pressure turbine section of the turbomachine 62. In such an example, properly torquing the first component 54 may reduce the likelihood of oil leakage from the stack.

Although the example first component 54 is a component of the turbomachine 62 various components in various systems could be torqued by the portable torque workstation 10.

Determining the torque procedure at the step 116 uses information from the step 108 and the step 120. The torque procedure specifies how to torque the first component 54 to achieve the desired clamp load. The determination is made prior to backing off the component at the step 112, or after backing off the component at the step 112.

If torquing a plurality of components, the torque procedure may specify a specific order for applying the seating pass to each of the components. In such an example, the evaluation pass may be executed on each component in the plurality of the components prior to executing the seating pass on any of the components.

At the step 120, the first component 54 is torqued during a seating pass according to the torque procedure. FIG. 2C represents the first component 54 after the seating pass. Notably, the first component 54 is fully seated relative to the second component 58 after the seating pass. The first component 54 is also applying a desired clamp load after the seating pass.

After the seating pass, the portable torque workstation may provide a pass or fail indicator indicating if the first component 54 was successfully torqued according to the seating pass. The portable torque workstation 10 also may provide, through the printer 30 or display 22, a plot of a torque versus angle-of-turn curve.

In some examples, a torque curve is provided real-time (as torque is applied to the first component 54 during the seating pass). The torque curve features the minimum applied torque, the maximum applied torque, the average applied torque, and friction values.

The torque versus angle-of-turn curve and other data may be stored in the memory portion 46 of the portable torque workstation 10 for retrieval and study at a later time. The stored data is used to improve the accuracy of future seating passes, for example.

The final report produced by the portable torque workstation 10 also may include the temperature, time, a serial number of the first component 54 and the operator utilizing the torque tool 14 when applying the torque procedure to the first component 54.

The portable torque workstation 10, after the step 120, may be moved to another component and the method 100 repeated.

Features of the disclosed examples include a portable torque workstation that is able to adjust torque levels for specific components. Since very few adjustments are required, the portable torque workstation may be used as a training tool for mechanics. The portable torque workstation saves considerable time over other, more manual, torquing procedures.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A component torquing method, comprising:
applying torque to a component during an evaluation pass;
collecting data during the evaluation pass;
using the data to determine a torque procedure for the component, the component predicted to have a desired clamp load after the torque procedure; and
torquing the component according to the torque procedure.

2. The component torquing method of claim 1, wherein the data comprises measurements of factors that influence the torque procedure required to achieve a desired clamp load.

3. The component torquing method of claim 1, wherein the data comprises friction between the component and another component that is secured to the component.

4. The component torquing method of claim 1, including plotting a torque verses angle-of-turn curve based on the torque procedure applied to the component.

5. The component torquing method of claim 1, including reversing the torquing on the component after the evaluation pass and prior to torquing the component according to the torque procedure.

6. The component torquing method of claim 1, wherein the torque procedure is applied during a seating pass.

7. A component torquing method, comprising:
torquing a component during an evaluation pass;
using information from the evaluation pass to determine a torque procedure that will result in the component having a desired clamp load; and
performing the torque procedure on the component.

8. The component torquing method of claim 7, wherein the component is one of a plurality of components, and the torque procedure includes performing the torque procedure on the component before or after performing torque procedures on other components in the plurality of components.

9. The component torquing method of claim 7, wherein the information from the evaluation pass includes static friction measurements and dynamic friction measurements.

10. The component torquing method of claim 7, including plotting a torque verses angle-of-turn curve based on the torque procedure applied to the component.

11. A portable torque workstation, comprising:
a torque tool; and
a controller that controls the torque tool to apply a torque procedure to a component, the torque procedure determined by the controller at the location of the component and based in part on data collected when applying torque to the component during an evaluation pass.

12. The portable torque workstation of claim 11, wherein the torque tool comprises an electric torque wrench having a servomotor.

13. The portable torque workstation of claim 11, including a display screen configured to display a torque verses angle-of-turn curve associated with the application of the torque procedure to the component.

14. The portable torque workstation of claim 11, wherein the component comprises a turbomachine component.
